(19) United States
(12) Patent Application Publication
(10) Pub. No.: US 2012/0050555 A1
(43) Pub. Date: Mar. 1, 2012

(54) Image generating apparatus, image generating method, program and recording medium

(75) Inventor: Toshio Shimizu, Tokyo (JP)

(73) Assignee: NEC BIGLOBE, LTD., Tokyo (JP)

(21) Appl. No.: 13/137,350

(22) Filed: Aug. 8, 2011

(30) Foreign Application Priority Data
Aug. 26, 2010 (JP) 2010-189903

(51) Int. Cl. H04N 5/225

(52) U.S. Cl. 348/220.1; 348/E05.024

(57) ABSTRACT

The present invention displays, based on multiple original images, multiple images as if pieces of paper were actually being flipped. The present invention is an image generating apparatus for generating, from input multiple original still images, altered pictures and arranging the original still images and the generated altered pictures to form content images used for creating moving images, the apparatus comprising: a memory device that stores altering means to generate, from the original still image, multiple altered pictures with different alteration levels; and an image processing device that uses the altering means to generate, from each of the multiple original still images, multiple altered pictures with different alteration levels and that generates content images in which the generated altered pictures are disposed between the multiple still original images with the alteration levels being gradually changed.

This application is based upon and claims the benefit of priority from Japanese patent application No. 2010-189903, filed on Aug. 26, 2010, the disclosure of which is incorporated herein in its entirety by reference.

### BACKGROUND OF THE INVENTION

1. Field of the Invention

The present invention relates to an image generating apparatus for generating, from multiple original images, multiple images used for forming moving images.

2. Description of the Related Art

Currently, various types of content are displayed through networks or recording media. A technique for displaying animation as content is disclosed in JP2004-302537A.

The technique disclosed in JP2004-302537A is provided to solve a problem that, when one piece of data or differential image data is assigned to each frame of an animation, a large amount of image data is required. The technique forms image information of altered still images, which are obtained by altering a still picture, by using an operation that is based on image information of the still picture, controls formation of the altered image information based on an instruction signal, and controls timings of the altered image information to display the altered still pictures as animated images in response to an operation through a mobile terminal or the like.

Content types have been diversified, and there is a need for various kinds of content. Examples of the content types include content similar to flip cartoons. The flip cartoons are provided by quickly flipping multiple pieces of paper on which gradually changing pictures are drawn. The technique disclosed in JP2004-302537A can display sequential animated pictures, but the technique cannot display pictures as if the pieces of paper were actually being flipped.

### SUMMARY OF THE INVENTION

The present invention provides an image generating apparatus for generating, from multiple original images, multiple images to be displayed as if pieces of paper were actually being flipped.

An image generating apparatus according to the present invention is an image generating apparatus for generating, from input multiple original still images, altered pictures and arranging the original still images and the generated altered pictures to form content images used for creating moving images, the apparatus comprising: a memory device that stores altering means to generate, from the original still image, multiple altered pictures with different alteration levels; and an image processing device that uses the altering means to generate, from each of the multiple original still images, multiple altered pictures with different alteration levels and generates content images in which the generated altered pictures are disposed between the multiple still original images with the alteration levels being gradually changed.

An image generating method according to the present invention is an image generating method executed in an image generating apparatus, including a memory device that stores altering means to generate, from an original still image, multiple altered pictures with different alteration levels, generating altered pictures from sequentially input multiple original still images, and arranging the original still images and the generated altered pictures to form content images used for creating moving images, wherein an image processing device uses the altering means to generate, from each of the multiple original still images, multiple altered pictures with different alteration levels and generates content images in which the generated altered pictures are disposed between the multiple still original images with the alteration levels being gradually changed.

A program according to the present invention causes a computer system to execute the method. A recording medium according to the present invention stores therein the program.

### BRIEF DESCRIPTION OF THE DRAWINGS

FIG. 1 is a block diagram illustrating a configuration of an exemplary embodiment of an image generating apparatus according to the present invention;

FIG. 2 is a block diagram illustrating an operation of each device illustrated in FIG. 1 and stored contents;

FIG. 3 is a flow chart showing an operation of the embodiment illustrated in FIG. 1;

FIG. 4 is a block diagram illustrating a configuration of another exemplary embodiment of the image generating apparatus according to the present invention;

FIG. 5 is a block diagram illustrating an operation of each device illustrated in FIG. 4 and stored contents;

FIG. 6 is a flow chart showing an operation of the embodiment illustrated in FIG. 4;

FIG. 7 is a diagram illustrating an operation performed in each of the exemplary embodiments to create content images from original still images;

FIG. 8 is a diagram illustrating the operation performed in each of the exemplary embodiments to create content images from the original still images;

FIGS. 9(A) to 9(C) are diagrams illustrating the operation performed in each of the exemplary embodiments to create content images from the original still images;

FIGS. 10(A) to 10(C) are diagrams illustrating the operation performed in each of the exemplary embodiments to create content images from the original still images;

FIG. 11 is a diagram illustrating the operation performed in each of the exemplary embodiments to create content images from the original still images; and

FIG. 12 is a diagram illustrating the operation performed in each of the exemplary embodiments to create content images from the original still images.

### EXEMPLARY EMBODIMENTS

Now, exemplary embodiments will be described with reference to the drawings.

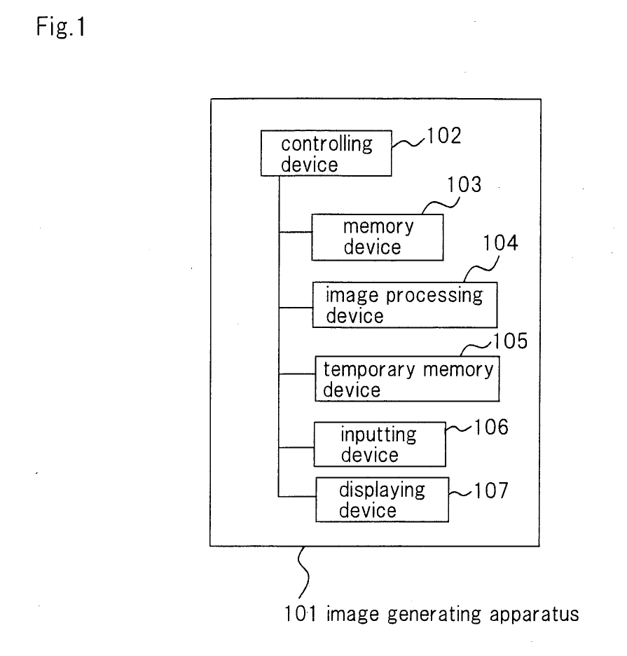

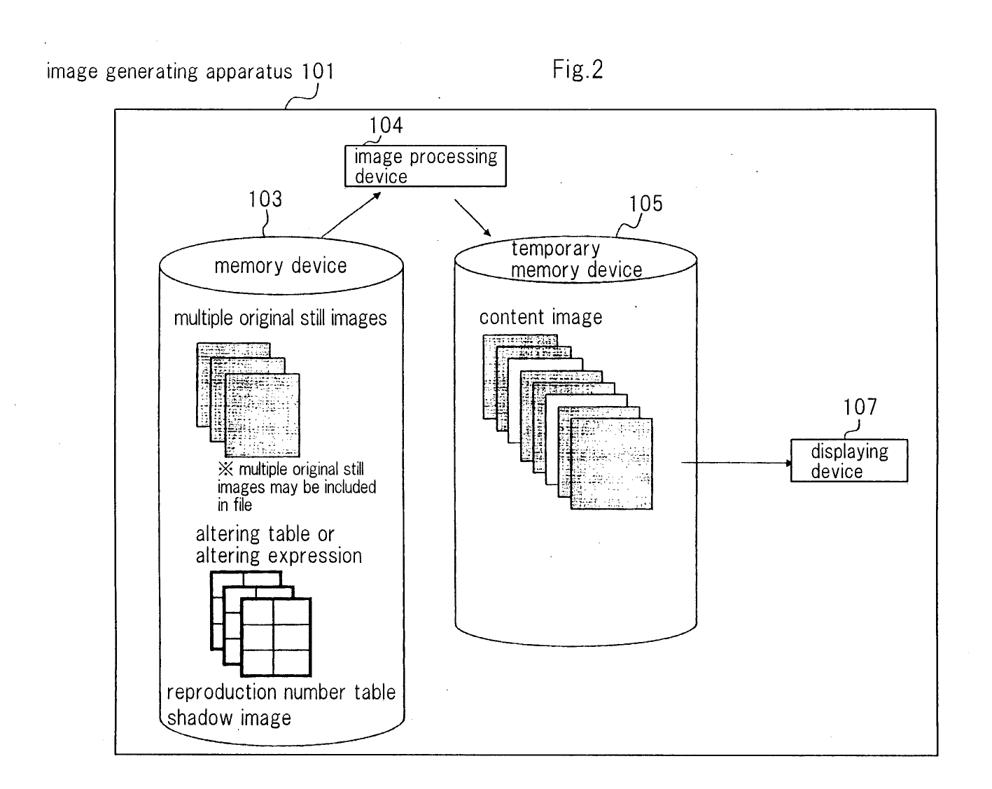

FIG. 1 is a block diagram illustrating a configuration of an exemplary embodiment of an image generating apparatus according to the present invention. FIG. 2 is a block diagram illustrating an operation of each device illustrated in FIG. 1 and stored contents.

Image generating apparatus 101 includes controlling device 102, memory device 103, image processing device 104, temporary memory device 105, inputting device 106, and displaying device 107. Image generating apparatus 101 generates, from pre-stored multiple original still images, content images including moving images by using an altering table (or an altering expression), and displays the content images.

Controlling device 102 controls each device. Memory device 103 stores original still images, an altering table (or an altering expression) for generating altered pictures from the original still images, a reproduction number table for accumulating the numbers of the original still images and the altered pictures to be reproduced, and shadow images for attaching the shadows to the original still images and the altered pictures. Memory device 103 also stores a program for causing the controlling device to operate.

Image processing device 104 reads out from memory device 103 the original still images and the altering table (or the altering expression) to generate altered pictures from the original still images, refers to the reproduction number table to reproduce the original still images and the altered pictures in accordance with the numbers accumulated, attaches shadows to the images based on the shadow images, and arranges the images in the order of moving images to generate content images.

Temporary memory device 105 temporarily stores the content images created by image processing device 104, and outputs the content images to displaying device 107 in sequence.

Inputting device 106 is used to input a program that is to be stored in memory device 104 and causes controlling device 102 to operate, to input operations to execute the program, and to input files such as original still images.

Displaying device 107 sequentially displays the content images received in sequence from temporary memory device 105, and thereby the moving images are displayed.

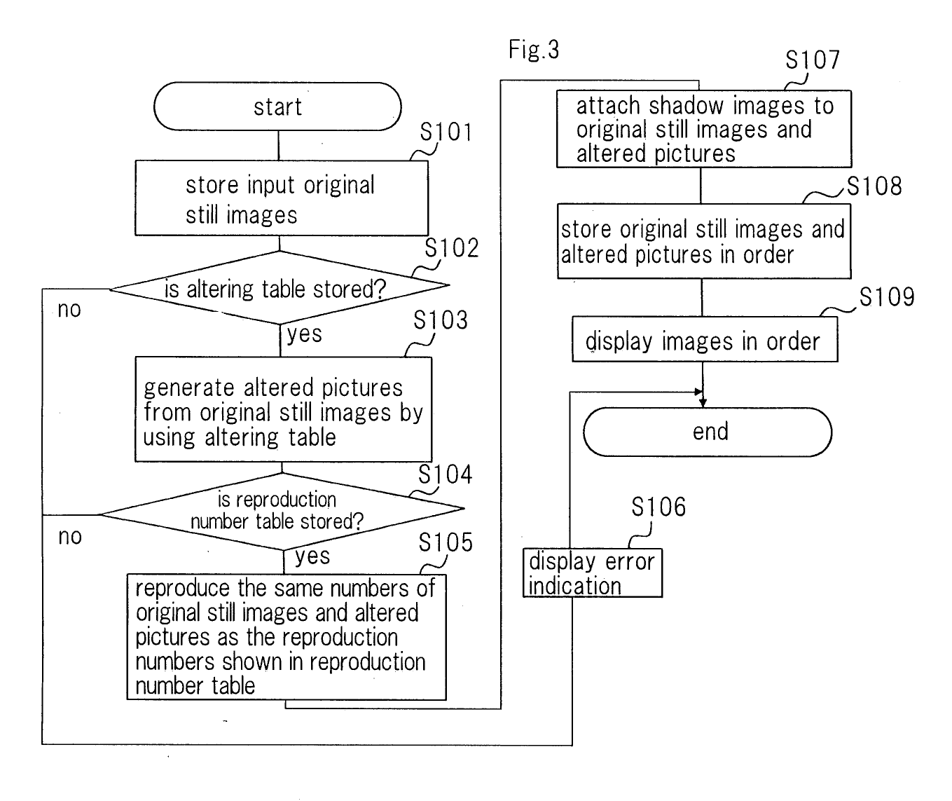

FIG. 3 is a flow chart showing an operation of the embodiment, and the moving image displaying operation according to the embodiment will be described below with reference to FIG. 3.

When the original still images and an instruction to display the moving images are input through inputting device 106, memory device 103 stores the input original still images (step S101). Multiple original still images may be input in sequence and stored into memory device 103 with the sequential numbers assigned to the corresponding images as well as a file, into which multiple original still images arranged in sequence are packaged, may be stored into memory device 103.

Controlling device 102 determines whether or not an altering table is stored in memory device 103 (step S102), and if no altering table is stored in memory device 103, controlling device 102 causes displaying device 107 to display an error indication (step S106). Then, the processing terminates.

In step S102, if controlling device 102 determines that an altering table is stored in memory device 103, controlling device 102 generates altered pictures from the original still images by using the altering table (step S103).

Next, controlling device 102 determines whether or not a reproduction number table is stored in memory device 103 (step S104), and if no reproduction number table is stored in memory device 103, controlling device 102 causes displaying device 107 to display an error indication (step S106). Then, the processing terminates.

In step S104, if controlling device 102 determines that a reproduction number table is stored in memory device 103, controlling device 102 reproduces the same numbers of the original still images and the altered pictures as the reproduction numbers shown in the reproduction number table (step S105).

Then, controlling device 102 attaches shadow images to the original still images and the altered pictures (step S107), makes content images in which the original still images and the altered pictures are arranged in order and causes temporary memory device 105 to store the content images (step S108), and causes temporary memory device 105 to output the content images sequentially to displaying device 107, thereby displaying moving images (step S109). Then, the processing terminates.

Next, another exemplary embodiment will be described with reference to the drawings.

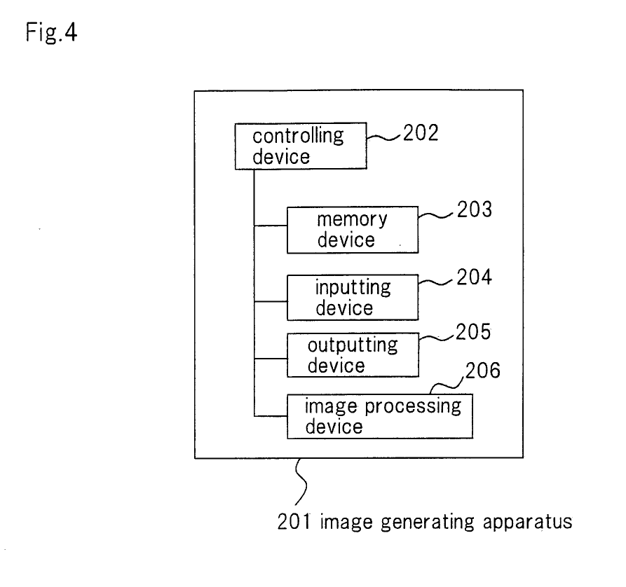

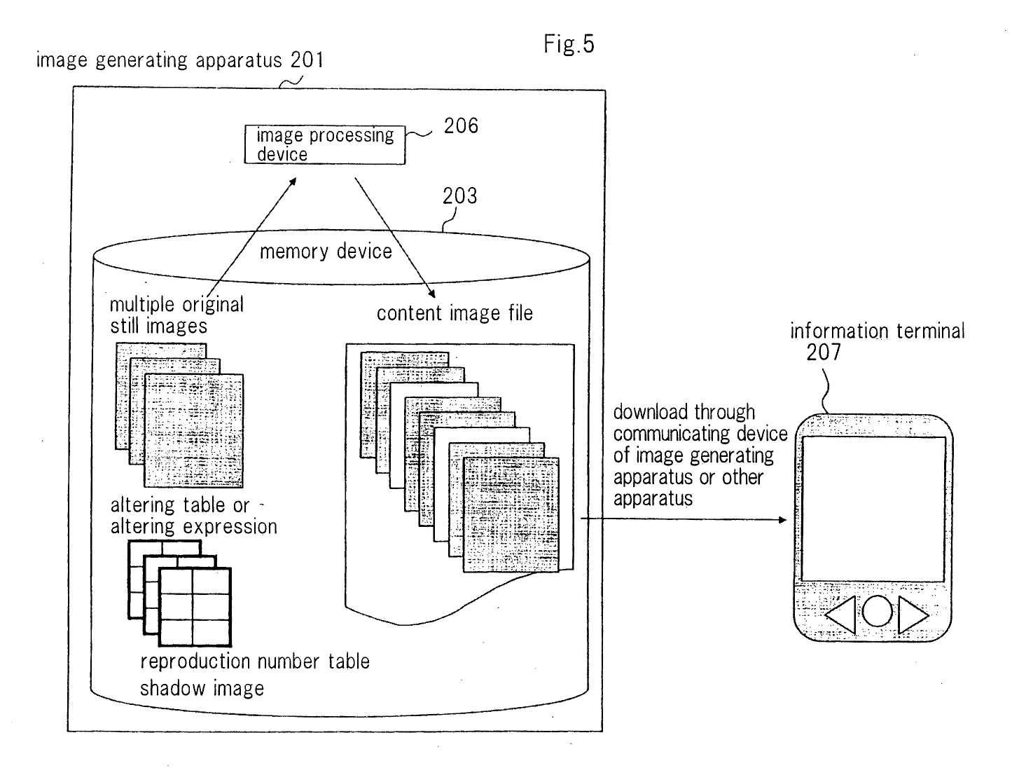

FIG. 4 is a block diagram illustrating a configuration of another exemplary embodiment of the image generating apparatus according to the present invention. FIG. 5 is a block diagram illustrating an operation of each device illustrated in FIG. 4 and stored contents.

Image generating apparatus 201 includes controlling device 202, memory device 203, inputting device 204, outputting device 205, and image processing device 206. Image generating apparatus 201 generates, from pre-stored multiple original still images, content images including moving images by using an altering table (or an altering expression), and outputs the content images.

Controlling device 202 controls each device. Memory device 203 stores original still images, an altering table (or an altering expression) for generating altered pictures from the original still images, a reproduction number table for accumulating the numbers of the original still images and the altered pictures to be reproduced, and shadow images for attaching shadows to the original still images and the altered pictures. Memory device 203 also stores a content image file in which the reproduced original still images and the reproduced pictures are arranged. Furthermore, memory device 203 also stores a program for causing the controlling device to operate.

Image processing device 206 reads out from memory device 203 the original still images and the altering table (or the altering expression) to generate altered pictures from the original still images, refers to the reproduction number table to reproduce the original still images and the altered pictures in accordance with the numbers accumulated, attaches the shadows to the images based on the shadow images, and arranges the images in order of moving images to generate a content image file.

Inputting device 204 is used to input a program that is to be stored in memory device 203 and causes controlling device 202 to operate, to input operations to execute the program, and to input files such as original still images.

The image generating apparatus according to the embodiment configured as described above transmits, in response to a download request from information terminal 207, the generated content image file to information terminal 207 via a communicating device (not shown) or other apparatus, and information terminal 207 plays the moving images by playing the downloaded content image file.

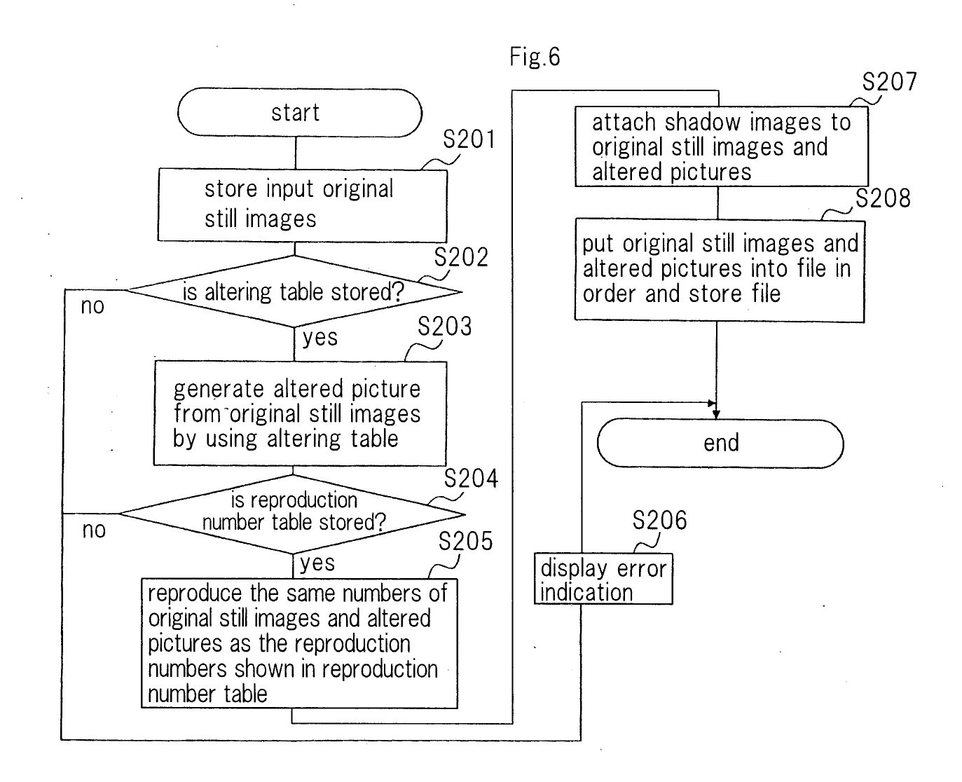

FIG. 6 is a flow chart showing an operation of the embodiment, and the moving image displaying operation according to the embodiment will be described below with reference to FIG. 6.

When the original still images and an instruction to display the moving images are input through inputting device 204, memory device 203 stores the input original still images (step S201). Multiple original still images may be input in sequence and stored into memory device 203 with the sequential numbers assigned to the corresponding images as well as a file into which multiple original still images arranged in sequence are packaged, may be stored into memory device 203.

Controlling device 202 determines whether or not an altering table is stored in memory device 203 (step S202), and if no altering table is stored in memory device 203, controlling device 202 causes a displaying device (not shown) to display an error indication (step S206). Then, the processing terminates.

In step S202, if controlling device 202 determines that an altering table is stored in memory device 203, controlling device 202 generates altered pictures from the original still images by using the altering table (step S203).

Next, controlling device 202 determines whether or not a reproduction number table is stored in memory device 203 (step S204), and if no reproduction number table is stored in memory device 203, controlling device 202 causes the displaying device to display an error indication (step S206). Then, the processing terminates.

In step S204, if controlling device 202 determines that a reproduction number table is stored in memory device 203, controlling device 202 reproduces the same numbers of the original still images and the altered pictures as the reproduction numbers shown in the reproduction number table (step S205).

Then, controlling device 202 attaches shadow images to the original still images and the altered pictures (step S207), makes content images in which the original still images and the altered pictures are arranged in order, puts the content images into a file, and causes memory device 203 to store the content image file (step S208). Then, the processing terminates.

After that, if a request to transmit the content image file is received from information terminal 207, controlling device 202 transmits the content image file stored in memory device 203 to information terminal 207.

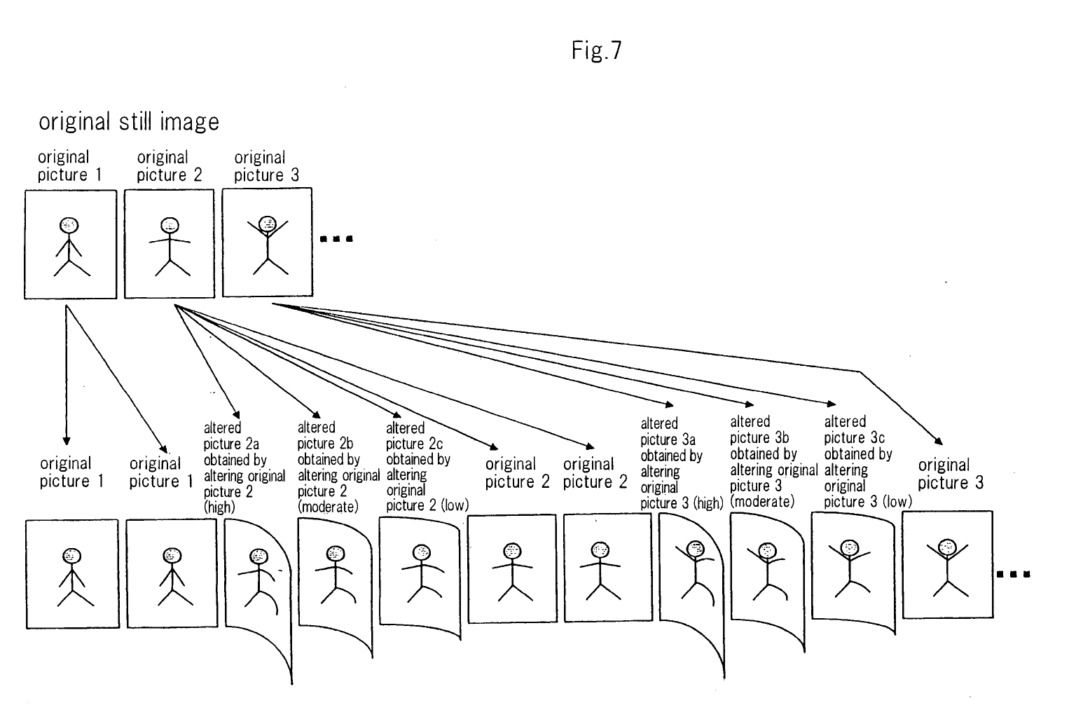

Now, the operation to form the content images from the original still images, which is performed in each exemplary embodiment described above, will be described below with reference to FIGS. 7 to 12.

In an example shown in FIG. 7, original pictures 1, 2, 3, and so on are input as original still images, and three altered pictures 2a to 2c are generated from original picture 2 and three altered pictures 3a to 3c are generated from original picture 3. In each altered picture, the order of a to c is descending order of alteration levels.

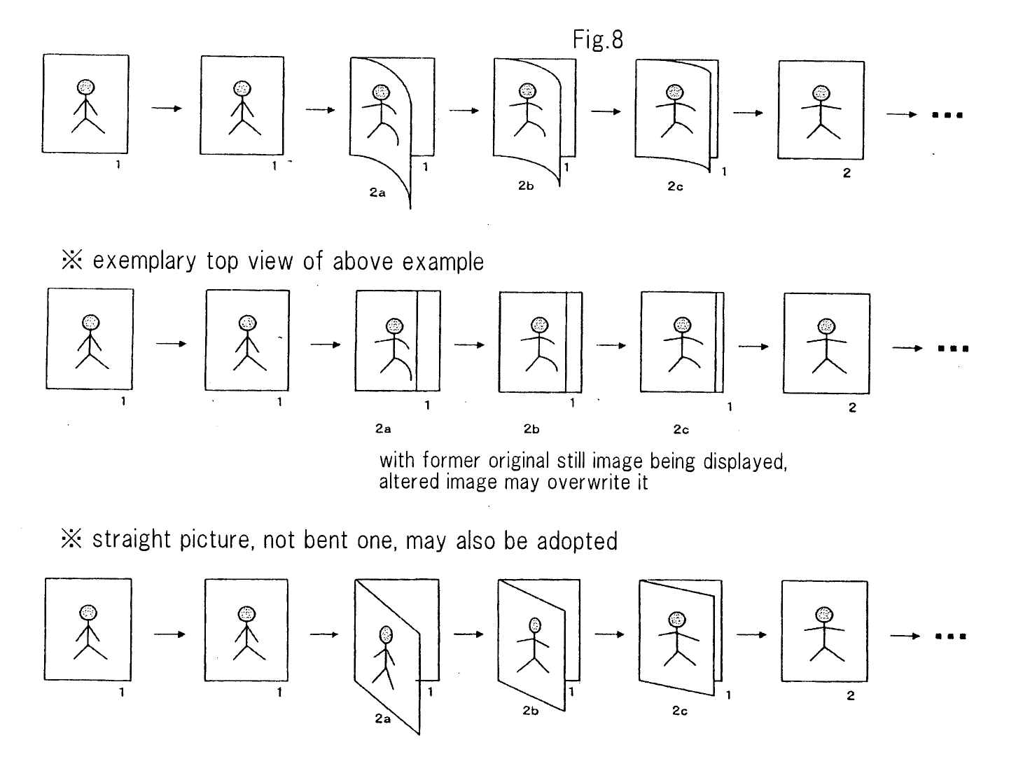

FIGS. 8 to 10 are diagrams illustrating types of altered pictures.

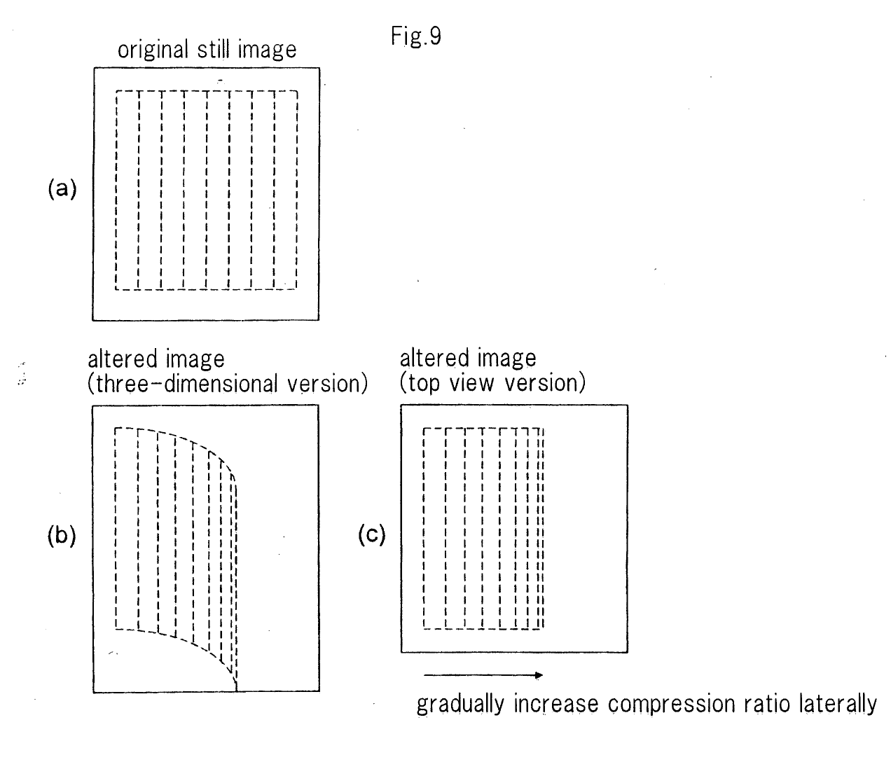

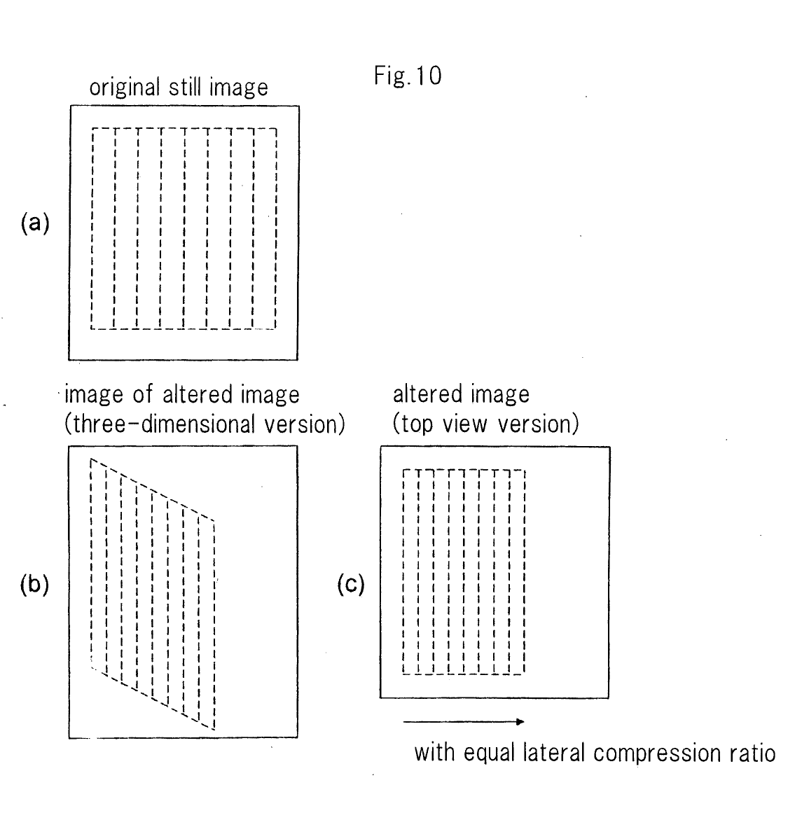

Although FIG. 9(A) or 10(A) shows the original still image, the altered pictures shown in the upper row of FIG. 8 are three-dimensional perspective views showing the motion of a flip cartoon being flipped by hand as illustrated in FIG. 9(B).

The altered pictures shown in the middle row of FIG. 8 are top views showing the motion of the flip cartoon being flipped as illustrated in FIG. 9(C) or 10(C).

The altered pictures shown in the lower row of FIG. 8 are views showing the motion of the flip cartoon being flipped without bending the pieces of paper on which the flip cartoon is drawn as illustrated in FIG. 10(B).

The generation of the above-described content images will be described in detail below.

First, the generation of the altered pictures will be described.

Memory device 103 or 203 stores an altering table (or an altering expression) for altering original still images based on types of altered pictures to be disposed.

For example, the altering table stores sets of coordinates of reference points arranged like rectangles or a matrix on an original image (original still image) and coordinates of changed points representing positions to which surrounding areas of the reference points are moved by alteration. In addition, if the coordinates of the reference points stored in the altering table are substituted into the altering expression, the coordinates of the changed points, which are stored in the altering table with the reference points as a set, are obtained. However, the altering table and the altering expression are not limited to these examples, and an existing image altering method may be adopted.

Tables 1 to 3 shown below are altering tables for creating altered pictures 2a to 2c (or altered pictures 3a to 3c).

TABLE 1

For altered picture a
reference point (x1, y1) → changed point (x′1, y′1)
reference point (x1, y2) → changed point (x′1, y′2)
reference point (x1, y3) → changed point (x′1, y′3)
.
.
.
reference point (xm, yn) → changed point (x′m, y′n)

TABLE 1

For altered picture a
reference point (x1, y1) → changed point (x′1, y′1)
reference point (x1, y2) → changed point (x′1, y′2)
reference point (x1, y3) → changed point (x′1, y′3)
.
.
.
reference point (xm, yn) → changed point (x′m, y′n)

TABLE 3

For altered picture c
reference point (x1, y1) → changed point (x″′1, y″′1)
reference point (x2, y2) → changed point (x″′2, y″′2)
reference point (x3, y3) → changed point (x″′3, y″′3)
.
.
.
reference point (xm, yn) → changed point (x″′m, y″′n)

Image processing device 104 or 206 uses the altering table (or the altering expression) stored in memory device 103 or 203 to generate a predetermined number of altered pictures from the original still images. If moved surrounding areas overlap each other or neighboring surrounding areas have a clearance therebetween, correction is performed with intermediate color between these areas.

Then, image processing device 104 or 206 refers to the reproduction number table stored in memory device 103 or 203 to reproduce the original still images and the altered pictures. Table 4 shows the stored contents in the reproduction number table to generate the content images illustrated in FIG. 7.

In the content images illustrated in FIG. 7, because each of altered pictures a, b, and c is used for two original pictures 1, one original still image is reproduced and no altered pictures are reproduced.

As the reproduction number table, a table in which default reproduction numbers are input may be prepared in advance and, after the default reproduction numbers are displayed on the displaying device, the reproduction numbers of the original still images and the altered pictures may be changed through an inputting device.

TABLE 4

| object to be reproduced | reproduction number |
|---|---|
| original still image | 1 |
| altered picture | 0 |

Then, image processing device 104 or 206 attaches shadow images to the original still images and the altered pictures by using the shadow images stored in memory device 103 or 203 for each type of the original still images and the altered pictures. Table 5 shows correspondences of the original still images and the altered pictures with the shadow images.

TABLE 5

| object to be processed | shadow image |
|---|---|
| original still image | kage_k.jpg |
| For altered picture a | kage_a.jpg |
| For altered picture b | kage_b.jpg |
| For altered picture c | kage_c.jpg |

Then, image processing device 104 or 206 arranges the original still images, the reproduced original still images, and the generated altered pictures (if available, reproduced altered pictures) in order, and stores these arranged images into temporary memory device 105 or stores a file of these images into memory device 203.

The images are arranged in either one of the following two orders.

The order (1) is as follows: a first original still image, a reproduced first original still image, a first altered picture of the first original still image (if available, a first altered picture of the reproduced first original still image), a second altered picture of the first original still image (if available, a second altered picture of the reproduced first original still image), . . . , a next original still image, a reproduced next original still image, a first altered picture of the next original still image (if available, a first altered picture of the reproduced next original still image), a second altered picture of the next original still image (if available, a second altered picture of the reproduced next original still image), . . . , and a last original still image.

The order (2) is as follows: a first original still image, a reproduced first original still image, a first altered picture of a next original still image (if available, a first altered picture of a reproduced next original still image), a second altered picture of the next original still image (if available, a second altered picture of the reproduced next original still image), . . . , the next original still image, the reproduced next original still image, a first altered picture of a third original still image (if available, a first altered picture of a reproduced third original still image), a second altered picture of the third original still image (if available, a second altered picture of the reproduced third original still image), . . . , and a last original still image.

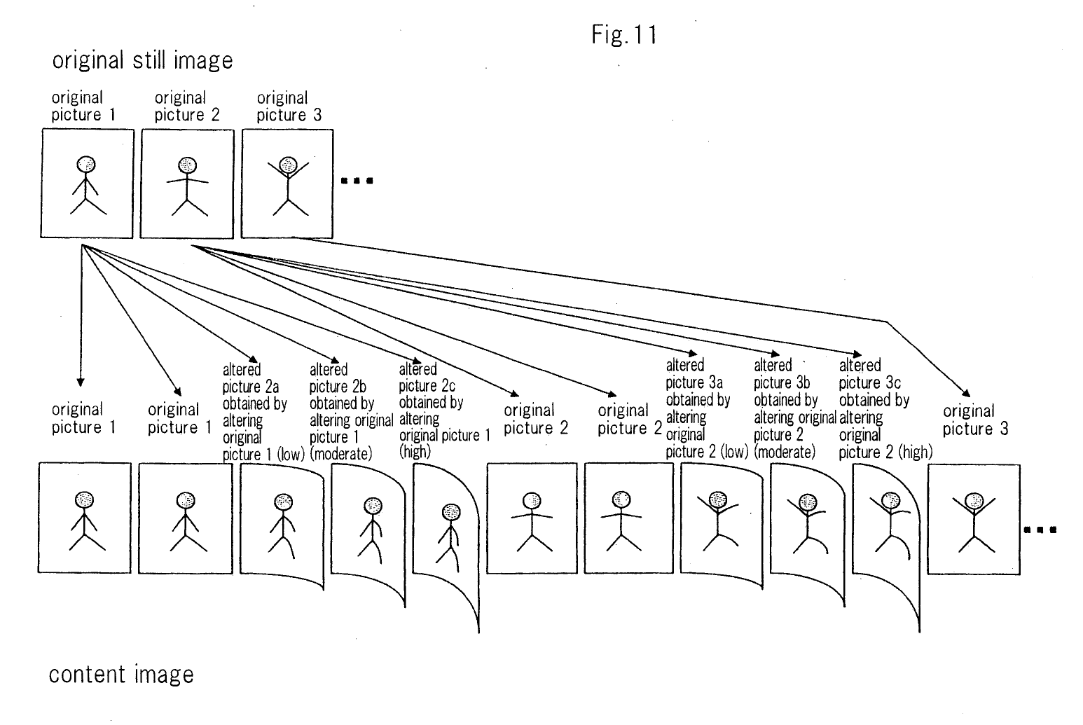

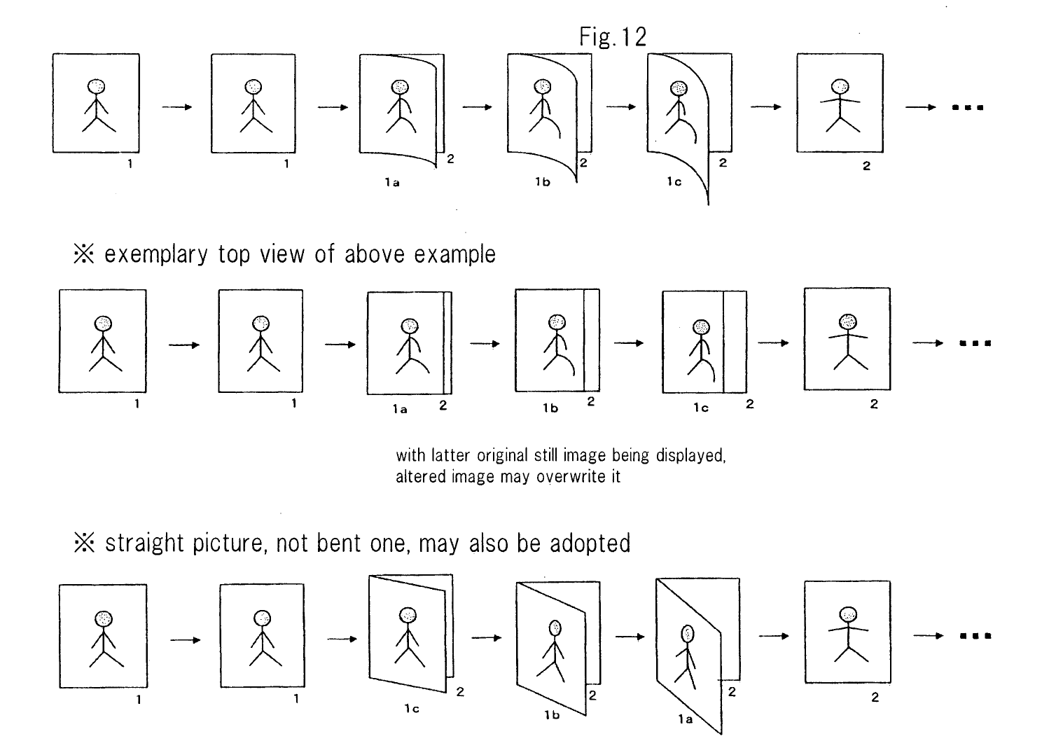

The Examples of FIGS. 7 and 8 show the order (2), and the examples of FIGS. 11 and 12 show the order (1).

The examples of FIGS. 7 and 8 represent sequentially flipped flip cartoons in which original picture 1, a start page, is a bottom page. Examples of FIGS. 11 and 12 represent sequentially flipped flip cartoons in which original picture 1, a start page, is a top page. Therefore, in the examples of FIGS. 7 and 8, the altered pictures to be disposed between the original pictures are derived from the latter page and disposed in descending order of alteration levels. In the examples of FIGS. 11 and 12, the altered pictures to be disposed between the original pictures are derived from the former page and disposed in ascending order of alteration levels.

In these exemplary embodiments, the altered pictures are disposed between the original pictures in the manner now described, and thereby the flipping motion of a flip cartoon can be represented.

It should be noted that each of the devices configuring the embodiments described above is constructed on a computer system including an inputting device, an outputting device, a memory device, and a controlling device. Therefore, the present invention includes a program for constructing each of the devices on the computer system and a recording medium storing therein the program.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

What is claimed is:

1. An image generating apparatus for generating, from input multiple original still images, altered pictures and arranging the original still images and the generated altered pictures to form content images used for creating moving images, the apparatus comprising:
a memory device that stores altering means to generate, from the original still image, multiple altered pictures with different alteration levels; and
an image processing device that uses the altering means to generate, from each of the multiple original still images, multiple altered pictures with different alteration levels and generates content images in which the generated altered pictures are disposed between the multiple still original images with the alteration levels being gradually changed.

2. The image generating apparatus according to claim 1, wherein said image processing device disposes the altered pictures in descending order of the alteration levels if altered pictures derived from a latter original still picture are used as the altered pictures to be disposed between the still original images.

3. The image generating apparatus according to claim 1, wherein said image processing device disposes the altered pictures in ascending order of the alteration levels if altered pictures derived from a former original still picture are used as the altered pictures to be disposed between the still original images.

4. The image generating apparatus according to claim 1, wherein the altering means is an altering table that stores a set of coordinates of reference points and coordinates of changed points representing positions to which surrounding areas of the reference points are moved by alteration.

5. The image generating apparatus according to claim 1, further comprising:
a temporary memory device that stores the content images; and
a displaying device that displays the content images stored in said temporary memory device.

6. The image generating apparatus according to claim 1, wherein said memory device stores a content image file including the content images,
the apparatus further comprising a controller that transmits the content image file stored in said memory device in response to a request from outside.

7. An image generating method executed in an image generating apparatus including a memory device that stores altering means to generate, from an original still image, multiple altered pictures with different alteration levels, generating altered pictures from input multiple original still images, and arranging the original still images and the generated altered pictures to form content images used for creating moving images, wherein an image processing device uses the altering means to generate, from each of the multiple original still images, multiple altered pictures with different alteration levels and generates content images in which the generated altered pictures are disposed between the multiple still original images with the alteration levels being gradually changed.

8. The image generating method according to claim 7, wherein the image processing device disposes altered pictures in descending order of alteration levels if altered pictures derived from a latter original still picture are used as the altered pictures to be disposed between the still original images.

9. The image generating method according to claim 7, wherein the image processing device disposes altered pictures in ascending order of alteration levels if altered pictures derived from a former original still picture are used as the altered pictures to be disposed between the still original images.

10. A program causing a computer system to execute a method according to claim 7.

11. A recording medium storing therein a program according to claim 10.
